(19) United States
(12) Patent Application Publication
(10) Pub. No.: US 2026/0187493 A1
(43) Pub. Date: Jul. 2, 2026

(54) COURSE OF ACTION LARGE LANGUAGE MODEL

(71) Applicant: Expression Networks LLC, Washington, DC (US)

(72) Inventor: Abir Ray, Washington, DC (US)

(21) Appl. No.: 19/409,176

(22) Filed: Dec. 4, 2025

Related U.S. Application Data
(60) Provisional application No. 63/740,444, filed on Dec. 31, 2024.

(51) Int. Cl. G06N 5/022; G06F 16/901; G06F 18/21; G06F 18/2113; G06N 3/0475; G06N 5/045

(52) U.S. Cl. CPC G06N 5/022; G06F 16/9024; G06F 18/2113; G06F 18/217; G06N 3/0475; G06N 5/045

(57) ABSTRACT

The present disclosure generally relates to a framework for recommending and evaluating courses of action (COAs) using large language models (LLMs). In accordance with some aspects of the present disclosure, a system may generate a structured data representation using a retrieval augmented generation (RAG) system connected to data sources and an LLM. The system may provide the structured data representation to a graph-based logical induction with differentiable reasoning (GLIDR) system. The GLIDR system may select one or more solving units and provide data from the structured data representation to the selected solving units. The selected solving units may generate action data that causes an actuating device to perform one or more operations. The system may provide this action data to the actuating device. In some implementations, the structured data representation includes a knowledge graph or a graph schema.

### CROSS-REFERENCE TO RELATED APPLICATIONS

This application claims the benefit of U.S. Provisional Patent Application No. 63/740,444, filed Dec. 31, 2024, the entire contents of which are incorporated herein by reference.

### TECHNICAL FIELD

This specification generally relates to large language model (LLM) systems, and more specifically to retrieval-augmented generation, graph-based logical induction, and satisfiability solving techniques for identifying and evaluating possible courses of action.

### BACKGROUND

Using complex, multi-domain data to generate actionable strategies can be challenging, even for advanced computing systems. Existing rule-based systems lack adaptability, while machine learning models may not provide transparent reasoning or consistent results. Large language models (LLMs) excel at processing unstructured data, but lack rigorous logical reasoning for complex planning.

### SUMMARY

This specification describes technologies for action determination using one or more connected machine learning models. These technologies generally involve extracting information from one or more data sources for processing by a collection of one or more large language models (LLMs). The LLMs can provide intermediate processed data to one or more processing units configured to generate recommended courses of action (COAs). The recommended COAs can include actions to be performed by a connected element, such as a robot, lever, or motorized actuator. COAs can include generated plans for a given environment or actions to be performed, e.g., provided as natural language output using one or more LLMs.

One aspect of the present disclosure relates to a computer-implemented method that involves generating a structured data representation using a RAG system communicably connected to one or more data sources and an LLM. The method includes providing the structured data representation to a graph-based logical induction with differentiable reasoning (GLIDR) system. The method includes selecting, using the GLIDR system, one or more solving units. The method includes providing data from the structured data representation to the selected one or more solving units. The method includes generating, by the selected one or more solving units, action data configured to cause an actuating device to perform one or more operations. The method includes providing the action data to the actuating device.

The one or more solving units may include at least one of a GLIDR optimization (GLIDR-OPT) system, an LLM contextual infilling engine, or a combinatorial optimization for a multi-domain planning and analysis system (COMPAS).

The structured data representation may include at least one of a knowledge graph or a graph schema. The one or more data sources may include one or more databases accessible via separate wireless networks.

The method may include performing, using the actuating device, the one or more operations after receiving the action data. Performing the one or more operations may include generating and transmitting one or more signals to one or more communicably connected devices.

Generating the structured data representation may include extracting information from the one or more data sources using dense passage retrieval and converting the extracted information into a knowledge graph representation using the LLM.

The GLIDR system may select the one or more solving units based on characteristics of the structured data representation, the characteristics including at least one of mission constraints, mission objectives, or potential adversary actions.

The method may include evaluating, using the LLM, a plurality of candidate COAs based on one or more criteria and ranking the plurality of candidate COAs. In some implementations, the action data corresponds to a highest-ranked COA. The one or more criteria may include at least one of resource efficiency, probability of success, or associated risk.

The method may include receiving feedback data from one or more user devices and refining one or more parameters of the GLIDR system based on the feedback data. In some implementations, the one or more parameters include at least one constraint, assumption, or operational parameter.

The method may include processing the action data using an iterative framework. In some implementations, processing the action data includes retrieving intelligence data from the one or more data sources using the RAG system, integrating the retrieved intelligence data into a knowledge representation system of the LLM, generating the action data using the GLIDR system and the selected one or more solving units, providing the action data to the actuating device, and receiving operational feedback for subsequent iterations.

The structured data representation may include a temporal event knowledge graph (TEKG) configured to represent time-dependent relationships between entities and events. In some implementations, the GLIDR system performs reasoning over the time-dependent relationships.

The method may include generating explainability data associated with the action data. In some implementations, the explainability data includes at least one of a confidence score, a reasoning pathway, or a potential counteraction, and providing the explainability data to one or more user devices.

Generating the action data may include analyzing a plurality of operational domains including land, air, sea, space, or cyber domains using domain-specific modules of the LLM and generating the action data to coordinate operations across the plurality of operational domains.

The method may be performed within a resource-constrained environment. In some examples, at least one of the RAG system, the LLM, or the GLIDR system is configured for edge computing through at least one of model compression, quantization, pruning, or federated learning.

The graph-based logical induction with differentiable reasoning system may implement a two-sweep advective message passing algorithm for processing the structured data representation. In some implementations, selecting the one or more solving units includes determining a complexity level of constraints within the structured data representation, identifying optimization requirements based on the complexity level, and dynamically allocating computational resources among the one or more solving units based on the optimization requirements.

The method may include transforming the structured data representation using one or more polynomial-time reduction algorithms, applying the one or more solving units to the transformed structured data representation, and selecting an output from the one or more solving units. In some implementations, the action data is generated based on the selected output.

Another aspect of the present disclosure relates to a system that includes one or more processors and memory storing instructions that, when executed by the one or more processors, cause the system to generate a structured data representation using a RAG engine communicably connected to one or more data sources and an LLM. The system may be configured to provide the structured data representation to a GLIDR service and select one or more solving units using the GLIDR service. The system may be configured to provide data from the structured data representation to the selected one or more solving units, which may generate action data that causes an actuating device to perform one or more operations. The system may be configured to provide the action data to the actuating device.

Another aspect of the present disclosure relates to a non-transitory computer-readable medium storing instructions that, when executed by one or more processors, cause the one or more processors to: generate a structured data representation using a RAG system communicably connected to one or more data sources and an LLM; provide the structured data representation to a GLIDR system; select, using the GLIDR system, one or more solving units; provide data from the structured data representation to the selected one or more solving units; generate, by the selected one or more solving units, action data configured to cause an actuating device to perform one or more operations; and provide the action data to the actuating device.

The techniques described in this specification can be implemented so as to realize one or more of the following advantages. The described systems offer explainability features, including confidence scores, detailed reasoning, or potential adversary counteractions. This information can provide transparency into the decision-making process and enable other systems or decision-makers to understand the rationale behind each COA recommendation.

The described techniques can integrate advanced LLM capabilities with robust solver components and explainability features. The described systems can provide a powerful tool for COA development and evaluation, thereby allowing the system to adapt to changing operational scenarios or provide transparent recommendations.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF FIGURES

FIG. 1 shows an example system for providing course of action (COA) recommendations, according to some implementations.

FIG. 2 shows an example mixed combinatorial-optimization and machine learning system for COA development, according to some implementations.

FIG. 3 shows an example user interface that supports COA prediction and evaluation, according to some implementations.

FIG. 4 is a diagram of an example COAA-LLM system architecture, according to some implementations.

FIG. 5 is a flowchart of an example method for COA optimization, according to some implementations.

Like reference numbers and designations in the various drawings indicate like elements.

### DETAILED DESCRIPTION

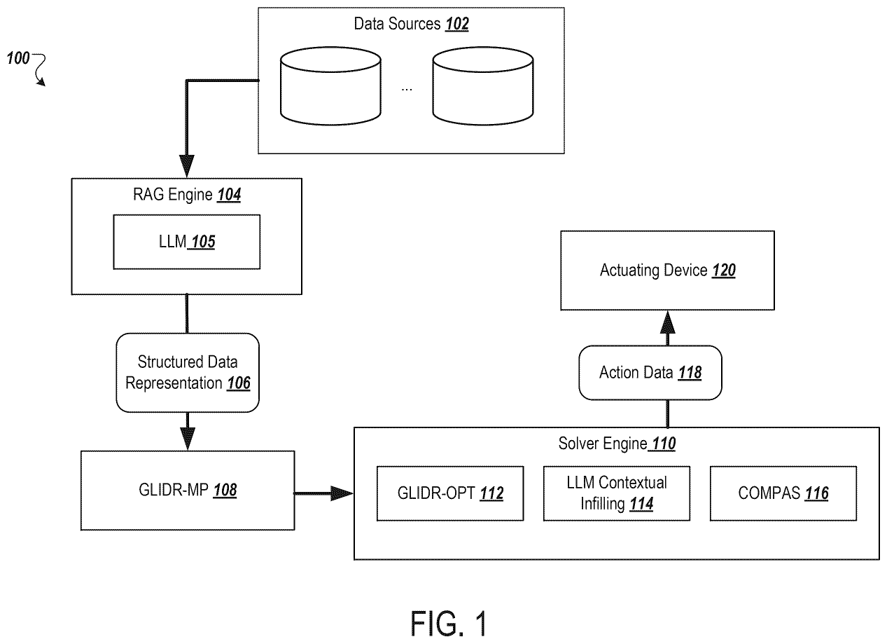

FIG. 1 shows an example system 100 for providing course of action (COA) recommendations, according to some implementations. The system 100 provides solutions or automated signals for performing one or more actions. The system 100 includes data sources 102, a retrieval augmented generation (RAG) engine 104, a graph-based logical induction with differentiable reasoning (GLIDR) message passing (MP) engine 108, a solver engine 110, and an actuating device 120. The system 100 can generate action data 118, e.g., by combining elements such as RAGs, LLMs, and satisfiability (SAT) solving techniques. The action data 118 can be configured to control the actuating device 120, e.g., to perform one or more operations.

The RAG engine 104 obtains data from the data sources 102 and uses an LLM 105 to generate a structured data representation 106. The RAG engine 104 provides the structured data representation 106 to the GLIDR-MP engine 108. The GLIDR-MP engine 108 can select or provide data to the solver engine 110. The solver engine 110 can include one or more of a GLIDR optimization (OPT) 112, LLM contextual infilling 114, or combinatorial optimization for multi-domain planning and analysis system (COMPAS) 116. The solve engine 110 generates action data 118. The action data 118 can include data configured to cause the actuating device 120 to perform one or more operations. Operations performed by the actuating device 120 can include transmitting data to one or more communicably connected devices, e.g., using one or more modems of a device, or physically moving an actuating device, such as a movable arm, lever, or motor.

In some implementations, the RAG engine 104 receives intelligence data from the data sources 102 and generates enriched intelligence data, e.g., in the form of the structured data representation 106. The RAG engine 104 can use dense passage retrieval to search through historical course of actions (COAs), informational doctrines, or operational scenarios. The RAG engine 104 can be used to observe or retrieve relevant intelligence data from various sources, e.g., one or more of the data sources 102. The RAG engine can ensure the most current or pertinent information is provided to the system 100. The LLM 105 can be trained to perform operations corresponding to an observe, orient, decide, and act (OODA) loop. The RAG engine 104 can implement dense passage retrieval techniques for efficient information extraction from data corpuses, such as military corpora. The RAG engine 104 can integrate a transformer-based architecture, e.g., for contextual understanding and generation of COAs.

In some implementations, the RAG engine 104 generates the structured data representation 106. For example, the LLM 105 of the RAG engine 104 can translate data obtained by the RAG engine 104 into a structured or formal representation, e.g., corresponding to one or more predetermined or variable parameters. In some cases, a structured formal language representation for objects, objectives, or affordances can be used by the LLM 105. The representation can include links representing relationships between metadata, e.g., for LLM consumption. A formal language for generating the structured data representation 106 can be represented in knowledge graph form, leveraging graph databases, inductive learning systems, or LLMs for effective processing. In some cases, a comprehensive knowledge graph schema can be used by the system 100. For example, the graph schema can capture entities, relationships, or attributes relevant to operations for action data determination, e.g., for emergency management and public safety, healthcare operations, urban planning and smart cities, supply chain and logistics, environmental management, corporate strategy and operations, military operations, research and development, or a combination of these among others. Ontology mapping techniques can be implemented by the system 100, e.g., to align with existing taxonomies or integrate automated knowledge extraction from unstructured document resources.

In some implementations, the structured data representation 106 can be used to identify mission constraints, mission objectives, or potential adversary actions. Constraints can include one or more of physical constraints, constraints on a successful result, context, resource limitations, or the like. Adversary can include an entity that might hamper a given objective, e.g., weather events that disrupt a supply chain.

In some implementations, the GLIDR-MP engine 108 selects an appropriate solver component. For example, the GLIDR-MP engine 108 can select one or more elements of the solver engine 110 to process data included in the structured data representation 106. The elements can include one or more of GLIDR-OPT 112, e.g., for optimization, the LLM contextual infilling 114, e.g., for incomplete or ambiguous data, or COMPAS, e.g., for complex combinatorial challenges. The core GLIDR reasoning engine can include the GLIDR-MP engine 108, e.g., for efficient message passing and the GLIDR-OPT 112, e.g., for flexible optimization. One or more GLIDR elements can be built around differentiable databases, e.g., allowing data-efficient learning and adaptability. The system 100 can use a specialized predicate language and graph-database query structure to generate complex solutions, extending the GLIDR concept to include multiple solver engines like COMPAS, GLIDR-OPT, and LLMs for knowledge graph representation and satisfiability concept generation.

In some implementations, the GLIDR-MP engine 108 can perform a two-sweep advective message passing algorithm, e.g., to ensure efficient training convergence. In some implementations, the GLIDR-OPT 112 offers flexibility with various solver methods, incorporating regressive learning algorithms and LLMs. This dual approach can deliver improved performance in generating and refining COAs compared to existing approaches. In some cases, the system 100 can use one or more custom neural network layers, e.g., for graph processing or implementing backpropagation through time (BPTT) for efficient training on temporal graph structures.

In some implementations, the GLIDR-OPT 112 can implement one or more hybrid optimization techniques that combines gradient-based approaches with combinatorial optimization methods. In some cases, adaptive learning rate schedules can be used, e.g., for improved convergence in dynamic scenarios.

In some implementations, the LLM contextual infilling 114 works in conjunction with the COMPAS 116, e.g., to iteratively adjust constraints or assumptions or refine COAs to align with mission requirements. This iterative adjustment process, combined with optimization techniques of the GLIDR-OPT 112, can help ensure the generation of COAs that are well-suited for dynamic operational environments.

In some implementations, the system 100 integrates the COMPAS 116 solver into a COA generation pipeline. The system 100 can implement polynomial-time reduction algorithms, e.g., for transforming military planning problems into SAT instances or developing heuristics for efficient solution space exploration. The COMPAS 116 can include a custom satisfiability solver environment to address the combinatorial complexity posed by problems such as COA development. These tools can employ polynomial time reductions across NP-complete problem instances, e.g., to efficiently represent satisfiability of constrained problems in different ways. For instance, the COMPAS 116 can transform SAT-type problems (e.g., 3-SAT, NAE-3-SAT, NAE-4-SAT) to MAXCUT or assignment problems, where alternative SOTA heuristic solvers can be brought to bear on the solution development. The system 100 can provide mechanisms to bypass difficulties in source domain (SAT) solutions. The COMPAS 116 can handle complex, multi-domain nature of an environment planning and analysis, and serve as a central capability in COA development and optimization.

In some implementations, the system 100 implements the COMPAS 116 solving framework, integrated with the GLIDR-MP engine 108. The system 100 can address complex or constrained problems inherent in course of action analysis (COAA). The COMPAS 116, with its ability to handle combinatorial optimization across NP-complete problem instances, can be used for generating COAs that are both innovative and feasible. Integration can help ensure that an LLM's output, such as the output of the system 100, aligns with tactical or strategic considerations, enabling planners to develop COAs that account for multi-domain operational constraints.

In some implementations, the LLM contextual infilling 114 can work in conjunction with the COMPAS 116, e.g., to iteratively adjust constraints and assumptions, refining COAs to align with mission requirements. This iterative adjustment process, combined with GLIDR-OPT's optimization techniques, can help ensure the generation of COAs that are well-suited for dynamic operational environments.

In some implementations, the solver engine 110 operates on constraints, objectives, or situational data to identify feasible COAs. The feasible COAs can be included in the action data 118. The action data 118 can include data related to emergency management and public safety, healthcare operations, urban planning and smart cities, supply chain and logistics, environmental management, corporate strategy and operations, military operations, research and development, or a combination of these among others.

In some cases, the system 100 evaluates or ranks one or more COAs. For example, the system 100 can evaluate or rank based on criteria such as resource efficiency, probability of mission success, or associated risks. In some cases, the action data 118 includes one or more actions. The action data 118 can include one or more ranked actions. Ranked actions can be performed in parallel or in sequence, e.g., with a predetermined or variable delay between actions. In some implementations, the actuating device 120 transmits data to one or more devices for human analyst feedback. Human analyst feedback can be used to refine aspects of the system 100, e.g., the constraints, assumptions, or parameters. Each of the constraints, assumptions, or parameters can be generated by the system 100. For example, constraints, assumptions, or parameters may not be provided by human but may be generated by the system 100. In some cases, one or more aspects are configured by a user, such as constraints, assumptions, or parameters.

In some implementations, the system 100 generates the action data 118 for emergency management and public safety. For example, the system 100 can use an ability to process complex, multi-source data and generate actionable strategies for emergency response planning. City managers and emergency coordinators can leverage the technology to develop comprehensive response plans for natural disasters, public health crises, or large-scale emergencies. The system 100 can include edge computing capabilities. Edge computing capabilities can help ensure continuous operation, e.g., even in connectivity-challenged environments, which can be helpful for disaster response scenarios.

In some implementations, the system 100 generates the action data 118 for healthcare operations. For example, healthcare systems can utilize the system 100 to optimize patient care pathways and resource allocation across multiple facilities. The system 100 can analyze patient data, facility capabilities, or resource constraints to generate efficient treatment plans and staffing strategies. For remote or rural healthcare facilities, the edge-optimized architecture can help ensure reliable decision support even with limited connectivity, which can enhance care delivery in underserved areas.

In some implementations, the system 100 generates the action data 118 for urban planning or smart cities. For example, the system 100 can develop or evaluate complex infrastructure or transportation plans. By integrating data from various urban systems, e.g., including traffic patterns, utility usage, or population demographics, the system 100 can generate optimized strategies for urban development, resource allocation, or public service delivery. The system 100 can handle multi-domain interactions which can be valuable for coordinating smart city initiatives, e.g., across transportation, utilities, or public services.

In some implementations, the system 100 generates the action data 118 for supply chain and logistics. For example, the system 100 can optimize complex supply chain networks or respond to disruptions. The system 100 can analyze global supplier networks, transportation routes, or inventory levels, e.g., to generate adaptive strategies for supply chain resilience. The system 100 can operate in edge environments, e.g., to support decision-making at remote warehouses or distribution centers. The system 100 can include multi-domain integration capabilities, e.g., to enable comprehensive supply chain visibility and coordination.

In some implementations, the system 100 generates the action data 118 for environmental management. For example, the system 100 can generate climate change mitigation actions or environmental resource management. The system 100 can process data from various environmental monitoring systems to develop strategies for, e.g., pollution control, resource conservation, or sustainable development. The system 100 can handle complex, interconnected systems, e.g., which can be particularly helpful in addressing multi-faceted environmental challenges.

In some implementations, the system 100 generates the action data 118 for corporate strategy and operations. For example, the system 100 can generate strategic actions or optimize operations across global operations, e.g., for small or large enterprises. The system 100 can, e.g., analyze market conditions, competitive landscapes, or internal capabilities to generate strategic options for market entry, expansion, or organizational transformation. The system 100 can operate across distributed environments or support decision-making across multiple business units or geographical locations.

In some implementations, the system 100 generates the action data 118 for research and development. For example, the system 100 can generate actions for complex research planning or execution, e.g., in connection with scientific organizations. Edge computing capabilities of the system 100 can enable data analysis or decision support, e.g., in remote field locations. Multi-domain integration can facilitate coordination across different research disciplines and methodologies.

Applications of the system 100 demonstrates versatility in handling complex decision-making scenarios across various civilian and commercial contexts. Capabilities of the system 100, including multi-domain data integration, edge operation, or sophisticated strategy generation, can provide improvements across technologies. The system 100 can include a scalable architecture and adaptable framework that can enable customization for specific implementations, e.g., while maintaining robust analytical capabilities.

While portions of this specification focus on action analysis for military operations, similar techniques can be used to generate action recommendations in other, non-military, environments. For example, techniques can be used for emergency management and public safety, healthcare operations, urban planning and smart cities, supply chain and logistics, environmental management, corporate strategy and operations, military operations, research and development, or a combination of these among others.

Course of Action Analysis (COAA) for modern military operations is challenging for a multitude of reasons. The complexity of COAA stems from many factors, e.g., the combinatorial nature of multi-domain operations, where decisions in one domain can trigger cascading effects across others; the dynamic and rapidly evolving battlespaces that require continuous reassessment and adaptation of strategies; and the need to process and analyze vast amounts of multi-source, multi-domain data in real time to inform decision-making.

Existing approaches to COAA struggle with these challenges. While Satisfiability solvers (SAT-solvers) can be effective for some types of problems, they can falter in the complexity and fluidity of multi-domain operations, as they can require precise, formal problem definitions that can be difficult to formulate in rapidly changing scenarios. Conversely, LLMs excel in natural language understanding and generation but lack the rigorous logical reasoning needed for detailed COAA. To overcome these limitations, this specification describes a novel approach that combines the complementary strengths of RAG, LLMs, and SAT-solving techniques. This hybrid system can perform one or more of the following operations: (i) utilize RAG to efficiently process and retrieve relevant information from vast, multi-domain datasets, providing context-rich input for COA generation; (ii) leverage LLMs'natural language understanding and generation capabilities to interpret complex scenarios and articulate nuanced COAs; (iii) employ SAT-solvers to ensure logical consistency and optimize the generated COAs within defined constraints.

By integrating these advanced technologies, a RAG and SAT-enhanced COA-LLM system can be used for COAA, e.g., CJADC2. The proposed techniques can deliver more comprehensive, adaptable, and logically sound COAs, e.g., empowering decision-makers, such as military decision-makers, to navigate complexities of modern, multi-domain operations with unprecedented effectiveness.

Some aspects of the present disclosure involve a COMPAS, such as the COMPAS 116 of FIG. 1. A COMPAS tool set can include a custom satisfiability solver environment. COMPAS can address combinatorial complexity in various problem domains. The techniques described herein can adapt this tool set for COA generation and optimization in multi-domain operations, e.g., to ensure the feasibility of generating complex, constrained strategies.

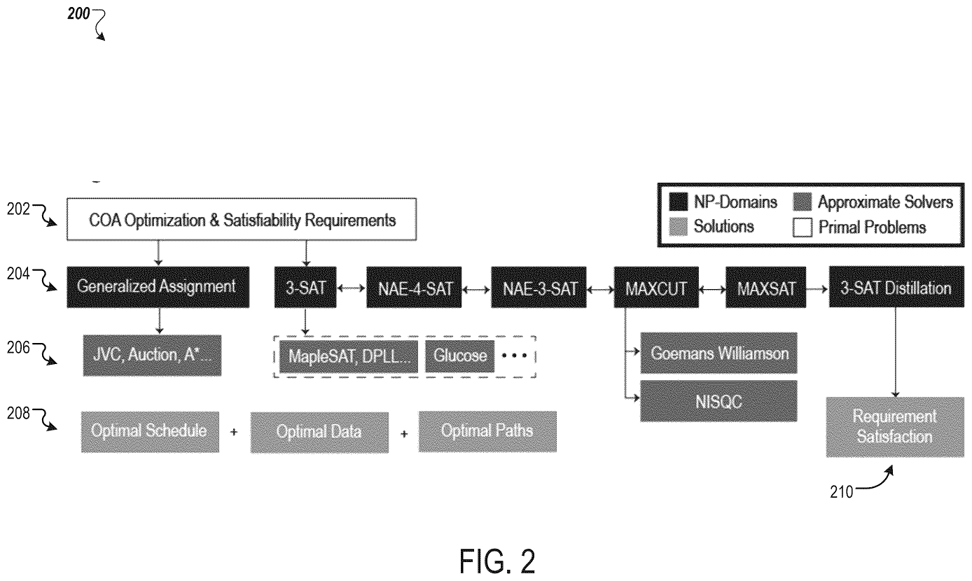

FIG. 2 shows an example mixed combinatorial-optimization and machine learning system 200 for COA development, according to some implementations. As shown in FIG. 2, the system 200 may receive COA optimization and satisfiability requirements 202, which define constraints, objectives, or operational parameters for a given planning scenario. These requirements 202 may specify mission goals, resource limitations, temporal constraints, or other factors that influence the generation of feasible COAs. The requirements 202 can be provided as structured data, natural language descriptions, or a combination of both, and may serve as input to subsequent processing stages within the system 200.

The system 200 can include multiple nondeterministic polynomial (NP) domains, such as a generalized assignment entity that processes the COA optimization and satisfiability requirements 202 to formulate an initial problem representation. The generalized assignment entity can transform input constraints into a mathematical or logical framework suitable for further analysis. In some implementations, the generalized assignment entity identifies decision variables, constraints, or optimization objectives that will guide the problem-solving process.

The NP domains 204 represent different formulations of computationally complex problems. Examples of NP domains 204 include 3-SAT, NAE-4-SAT, NAE-3-SAT, MAXCUT, MAXSAT, JVC, Auction, and A*, among other examples. Each of these domains can represent a specific type of satisfiability or optimization problem. The system 200 can use these NP domains 204 to represent complex problems in different ways. The bidirectional connections between these modules indicate how the system 200 can perform polynomial-time reductions in multiple directions, enabling flexible problem reformulation.

3-SAT can be used to represent a boolean satisfiability problem where each clause contains three literals. The system 200 can use this representation to analyze logical constraints or decision dependencies within a COA planning scenario. In some implementations, the 3-SAT module can receive input from other NP domains 204 or provide output to approximate solvers 206 for solution generation.

NAE-4-SAT can be used to represent a not-all-equal satisfiability problem with four literals per clause, where not all literals in each clause have the same truth value. This formulation can be useful for representing some types of operational constraints where diversity or redundancy is desired. The system 200 can transform problems between NAE-4-SAT and other representations to leverage different solving techniques.

The NAE-3-SAT module may represent a not-all-equal satisfiability problem with three literals per clause. This module can provide an intermediate representation between more complex formulations and simpler problem types. The system 200 can use the NAE-3-SAT module as part of a reduction chain that ultimately leads to more efficiently solvable problem representations.

MAXCUT can be used to represent a graph partitioning problem where the objective is to maximize the number of edges between two subsets of vertices. This formulation can be particularly useful for analyzing resource allocation, force distribution, or network optimization problems within COA planning. The system 200 may transform satisfiability problems into MAXCUT representations to leverage specialized optimization algorithms.

MAXSAT can be used to represent a maximum satisfiability problem where the objective is to satisfy as many clauses as possible, even if complete satisfaction is not achievable. This formulation can be valuable for handling over-constrained planning scenarios where there are trade-offs between competing objectives. The system 200 can use MAXSAT to identify suitable options when optimal solutions do not exist.

3-SAT can be used to perform a refinement or simplification process on 3-SAT problem representations. This module can reduce problem complexity, eliminate redundant constraints, or extract important structural features that facilitate more efficient solving. In some implementations, the 3-SAT distillation module can prepare problem instances for input to approximate solvers 206 or other downstream processing components.

The system 200 may include approximate solvers 206, which can generate solutions to the transformed problem representations. Examples of approximate solvers 206 include, but are not limited to, MapleSAT, Davis-Putnam-Logemann-Loveland (DPLL), Glucose, Goemans-Williamson, and noisy intermediate-scale quantum computing (NISQC). Each of these solvers can employ different heuristics or search strategies to identify satisfying assignments or near-optimal solutions. The system 200 can apply multiple solvers in parallel or in sequence to improve solution quality or robustness.

The MapleSAT solver may implement a conflict-driven clause learning algorithm with specialized branching heuristics. This solver can be particularly effective for some classes of satisfiability problems and may provide rapid solution generation for well-structured problem instances. In some cases, the system 200 may select MapleSAT based on characteristics of the problem representation or historical performance data.

The DPLL solver may implement Davis-Putnam-Logemann-Loveland algorithm, which uses backtracking search with unit propagation and pure literal elimination. This solver can provide a foundational approach to satisfiability solving, and may suitable for problems where more specialized solvers are not applicable. The system 200 can use DPLL as a baseline solver or as part of a portfolio of solving techniques.

The Glucose solver may implement a conflict-driven clause learning algorithm with a focus on clause database management and/or learned clause quality. This solver can be effective for industrial and structured problem instances. The system 200 may select Glucose based on problem features or as part of an ensemble solving approach.

The Goemans-Williamson solver may implement a semidefinite programming-based approximation algorithm for MAXCUT problems. This solver can provide provable approximation guarantees and generate high-quality solutions for graph partitioning or resource allocation problems. The system 200 can use Goemans-Williamson to refine solutions obtained from other solving techniques.

The NISQC solver may implement quantum computing approaches for optimization problems, leveraging noisy intermediate-scale quantum computing hardware or simulators. This allows the system 200 to cover solution spaces using quantum algorithms such as the Quantum Approximate Optimization Algorithm (QAOA) or variational quantum eigensolvers. The system 200 can use NISQC for problems where quantum approaches offer potential advantages over classical methods.

The system 200 may be configured to provide various solutions 208, which can represent optimized outputs generated by the approximate solvers 206 or other optimization modules. The solutions 208 may include, for example, an optimal schedule, optimal data, and optimal paths. These outputs collectively form a comprehensive COA solution.

An optimal schedule refers to a temporal ordering of actions or resource allocations that satisfies timing constraints and/or maximizes operational efficiency. This output can specify when specific operations should be initiated, how long they should continue, or how resources should be allocated over time. The system 200 can generate an optimal schedule based on mission requirements, resource availability, or other operational factors.

Optimal data represents information flows, communication patterns, or data distribution strategies that support COA execution. This output can specify how intelligence data should be collected, processed, or disseminated to support decision-making.

Optimal paths represent movement routes, communication pathways, or logical sequences of operations that achieve mission objectives. This output can specify how forces should be positioned, how resources should be transported, or how operations should be sequenced. The system 200 may determine optimal paths based on terrain analysis, threat assessments, or other operational considerations.

The system 200 may be configured to verify whether generated solutions meet all COA optimization and satisfiability requirements 210. For example, the system 200 may perform verification, validation, or quality assessment of proposed COAs. In some implementations, the system 200 can provide feedback to earlier stages to enable iterative refinement of solutions.

FIG. 2 shows an NP-reduction sequencing configuration that has been effective at increasing the robustness of polynomial time solution of satisfiability problems with continuous constraints, and shows a potential architecture for increasing the robustness of polynomial-time solution of COA satisfiability discovery. In this case, illustrating how future solutions can expand capability by integrating a NISQC solution. COMPAS can also be used to develop tamper-resistant logic for hardware designs.

The disclosed system can leverage inductive logic programming to develop custom predicate logic-based query techniques for context elicitation and iterative refinement of LLM outputs. By constructing models of how LLM systems store and retrieve information in ways that are quite different from human cognition, techniques described can generate a custom elicitation language, e.g., that combines the precision of logical languages with the expressiveness and flexibility of natural language. A current language and vison model capabilities span small 100M parameter models to larger open foundation models, such as Llama 3.1 405B.

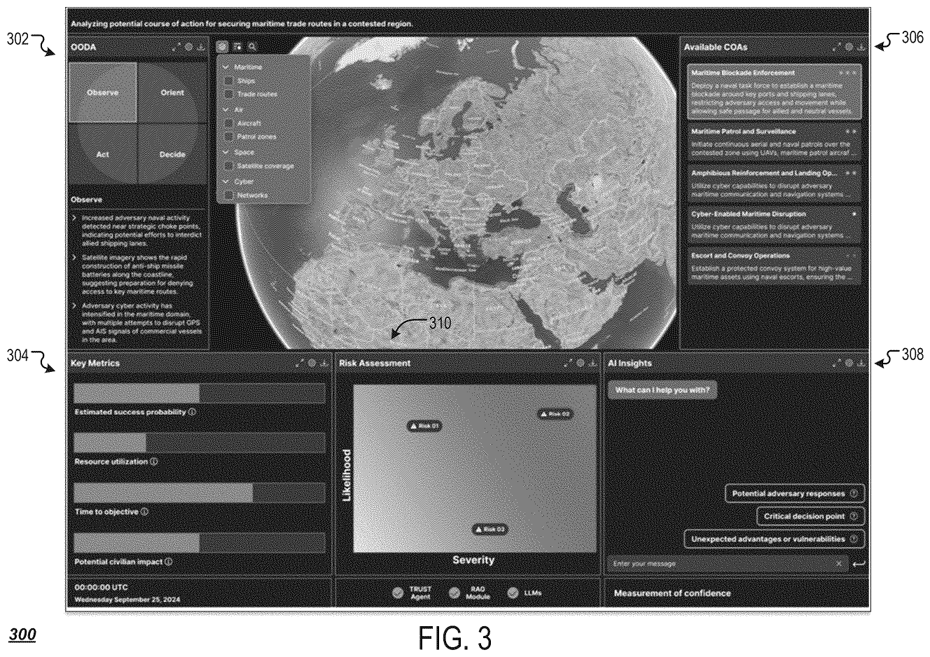

In some cases, planners and analysts can explore vast and complex data sets by asking natural language questions without requiring expertise in database queries or familiarity with the underlying data sources. This capability can allow a system to quickly transform multi-source intelligence, such as open-source, signals intelligence, or operational data, into actionable COA options quickly, e.g., within minutes. In an example workflow, e.g., shown in FIG. 3, an agent can start by using the disclosed system to retrieve summaries of intelligence reports related to a contested maritime zone, followed by querying the tool to identify adversary movements and patterns of behavior. The system can then uncover potential vulnerabilities or strategic opportunities, which can be mapped to inform or refine COAs, ensuring that decision-makers have real-time, data-driven insights to support mission-critical operations.

FIG. 3 shows an example user interface 300 that supports COA prediction and evaluation, according to some implementations. The user interface 300 includes an OODA loop 302, which illustrates the current phase of operation (observe, orient, act, or decide).

The user interface 300 displays key metrics 304, which include quantitative performance indicators such as resource utilization rates, mission progress percentages, or operational efficiency measures. These metrics can provide decision-makers with real-time visibility into system performance and operational status.

The user interface 300 also displays available COAs 306, which may list multiple COA options generated by the system 100. Each COA option can include summary information describing the proposed strategy, required resources, or expected outcomes.

Additionally, the user interface 300 displays AI insights 308, which may provide contextual analysis and recommendations generated by the LLM 105. These insights can highlight patterns, anomalies, or strategic considerations that may inform decision-making, offer explanations for the system's recommendations, or identify factors that could influence mission success.

The user interface 300 also provides a risk assessment 310, which includes a graphical representation of potential risks associated with different COAs. The risk assessment 310 can visualize risk factors along dimensions such as likelihood and severity. This enables decision-makers to evaluate trade-offs between different strategic options and understand the potential consequences of each available COA.

In some implementations, the disclosed system can include LLMs specifically tailored for COAA in multi-domain operations. A system, such as the system 100, can leverage advanced machine learning techniques to implement an OODA loop, e.g., aiming to identify disruptive Courses of Action (COAs) that enhance warfighter control over tempo and battle rhythm in the face of adversarial threats. By utilizing the complexity and dynamism inherent in multi-domain operations (MDO), the system seeks to create decisive wins through strategic surprise. The system can adapt precise mathematical reasoning to real-world operational contexts. The system can assist commanders in analyzing situational data, identifying options, and iterating on decisions based on new insights, enabling quick and effective decision-making. Designed to operate in resource-constrained environments, the architecture can focus on innovative strategies for land, air, sea, space, and cyber domains. The system can be used for military COAA, with the OODA Loop at its core, creating strategies that significantly influence both the pace and rhythm of engagement with adversaries.

The disclosed system can provide robust COA recommendations. The system can integrate LLMs with an OODA framework for adaptive decision-making, using end-to-end COA solvers to integrate RAG-enhanced and domain-specific LLMs with the OODA framework.

The disclosed system can provide knowledge representation and differentiable reasoning systems, which involves developing advanced reasoning systems that utilize knowledge graphs and differentiable databases to improve COA reasoning and decision-making efficiency. This capability provides the structured reasoning and data management functionality needed to support the LLM-driven decision-making process.

The disclosed system can perform COA optimization and orchestration, which refines and optimizes COA strategies using advanced orchestration and solver tools, ensuring that decisions are both innovative and feasible. This enhances the quality and transparency of COA generation in complex operational environments.

The disclosed system can provide multi-domain data integration and process automation, which involves integrating data from various military domains and automating COA development workflows using LLMs and RAG. This capability complements the decision-making and reasoning systems by providing critical data fusion that can be used for comprehensive COA development.

Additionally, the system can optimize for edge and austere environments, ensuring that LLMs and COA systems are optimized for resource-constrained environments, enabling effective operations in austere and disconnected conditions.

An advanced LLM system for COAA in multi-domain operations can employ a comprehensive, multi-faceted strategy, leveraging AI/ML to deliver a robust, scalable, and innovative solution. The system can integrate intelligence data through a RAG framework to inform a COAA-optimized LLM, which can orchestrate a selection and application of SAT solvers (e.g., GLIDR-OPT, LLM contextual infilling, and COMPAS SAT-solving tools) to generate, evaluate, or refine potential COAs. This dynamic and adaptive approach combines the strengths of RAG, LLM, and SAT-solving techniques to optimize military decision-making in complex scenarios.

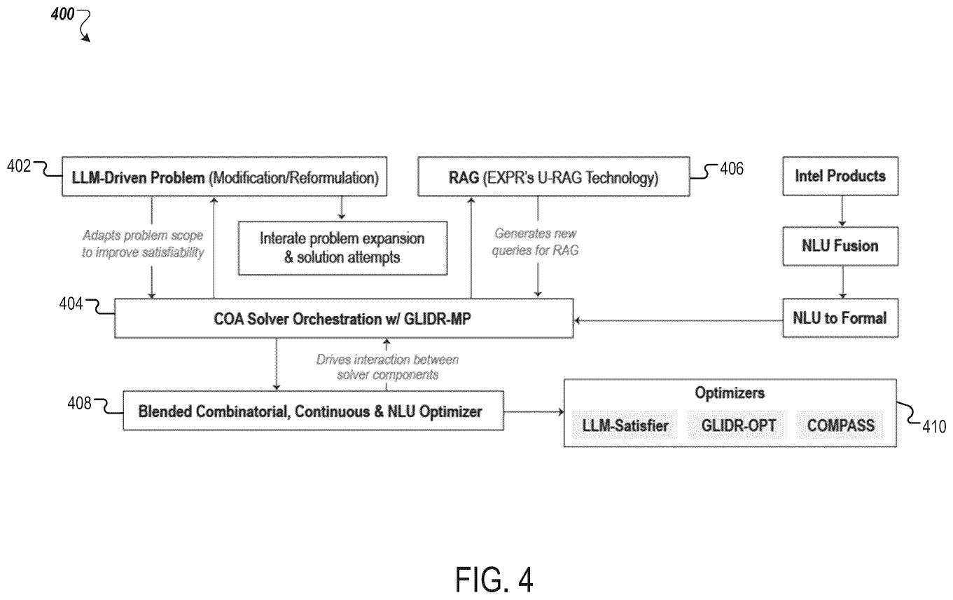

FIG. 4 is a diagram of an example COAA-LLM system architecture 400, according to some implementations. The architecture 400 can utilize one or more components to address complexities of COAA, e.g., within multi-domain operations and OODA loop applications. The architecture 400 can leverage RAG for dense passage retrieval, e.g., to search through historical COAs, military doctrines, and operational scenarios. In some examples, the architecture 400 shown in FIG. 4 can be used in the system 100 of FIG. 1. One or more elements or operations described in reference to FIG. 4 can be used or included in the system 100 of FIG. 1.

As shown in FIG. 4, the system can modify and reformulate an LLM-driven problem 402, e.g., to adapt problem scope and improve constraint satisfiability. The system can iteratively refine problem formulations based on feedback from downstream components. In some implementations, the system may expand or contract the problem space to identify more tractable solution pathways.

COA solver orchestration 404 with GLIDR-MP involves driving interactions between solver components. COA solver orchestration 404 may also involve coordinating selection and application of different solving techniques based on problem characteristics. In some implementations, COA solver orchestration 404 involves dynamically allocating computational resources among available solvers to optimize solution generation. Additionally, or alternatively, COA solver orchestration 404 may involve integrating problem formulations with retrieved intelligence data.

The RAG module 406 can use RAG techniques to generate new queries for information retrieval. The RAG module 406 can access diverse data sources to obtain relevant intelligence, historical COAs, or operational scenarios. The RAG module 406 can employ dense passage retrieval techniques to efficiently extract pertinent information from large corpora. The RAG module 406 can provide enriched intelligence data to assist with the COA generation process.

The blended optimizer 408 includes a blended combinatorial, continuous, and natural language understanding optimizer that processes data from COA solvers. The blended optimizer 408 can integrate multiple optimization approaches to handle diverse problem types and constraints. In some implementations, the blended optimizer 408 transitions between different optimization paradigms based on problem characteristics. The blended optimizer 408 can interface with optimizers 410, distributing optimization tasks among specialized solvers.

The optimizers 410 can include, e.g., an LLM-Satisfier, GLIDR-OPT, and COMPAS. The LLM-Satisfier may perform contextual infilling to address incomplete or ambiguous data in COA formulations. GLIDR-OPT can provide flexible optimization capabilities using various solver methods and/or regressive learning algorithms. COMPAS may handle complex combinatorial optimization challenges using polynomial-time reductions across NP-complete problem instances. In some implementations, optimizers 410 can operate in parallel or in sequence to generate, evaluate, and refine potential COAs.

As shown in FIG. 4, other intelligence products can interface with an NLU Fusion component that processes and integrates intelligence data from multiple sources. The NLU Fusion component may employ advanced natural language understanding techniques to extract structured information from unstructured intelligence reports. The NLU Fusion component may interface with an NLU to Formal component, which translates natural language representations into formal logical structures. The NLU to Formal component provides input(s) for COA solver orchestration 404, allowing the system to reason over formalized intelligence data in conjunction with problem formulations and retrieved information.

RAG may be complemented by COMPAS, which allows the system to efficiently represent and solve complex, constrained problems, such as those pertaining to military planning. The architecture 400 supports generation of sophisticated knowledge representations through differentiable database systems, e.g., GLIDR and Temporal Event Knowledge Graphs (TEKG), which can facilitate complex reasoning in military contexts.

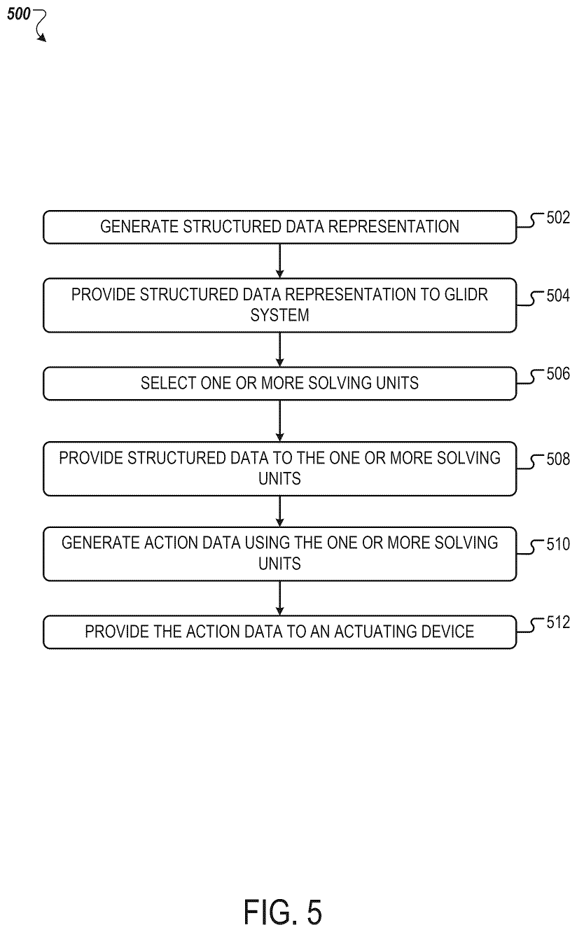

FIG. 5 is a flowchart of an example method 500 for COA optimization, according to some implementations. For clarity of presentation, the method 500 is described in the context of the preceding figures. For example, the method 500 can be performed by a system, such as the system 100 of FIG. 1, or by any suitable device, environment, software, hardware, or combination thereof. The operations of the method 500 can be performed in parallel, in combination, in loops, or in any order. The example method 500 shown in FIG. 5 can be modified or reconfigured to include additional, fewer, or different steps not shown in FIG. 5, which can be performed in the order shown or in a different order.

At 502, the system generates a structured data representation using a RAG system communicably connected to one or more data sources and an LLM. The structured data representation may include at least one of a knowledge graph or a graph schema, as described with reference to the system 100 of FIG. 1. The one or more data sources may include one or more databases accessible via separate wireless networks. In some implementations, generating the structured data representation includes extracting information from the one or more data sources using dense passage retrieval and converting the extracted information into a knowledge graph representation using the LLM. The structured data representation may include a TEKG configured to represent time-dependent relationships between entities and events.

At 504, the system provides the structured data representation to a GLIDR system. The GLIDR system may implement a two-sweep advective message passing algorithm for processing the structured data representation, as described with reference to the GLIDR-MP engine 108 of FIG. 1. The GLIDR system can perform reasoning over time-dependent relationships when the structured data representation includes TEKGs.

At 506, the system uses the GLIDR system to select one or more solving units. The GLIDR system may select the one or more solving units based on characteristics of the structured data representation. These characteristics may include mission constraints, mission objectives, potential adversary actions, etc. The selection process may include determining a complexity level of constraints within the structured data representation, identifying optimization requirements based on the complexity level, and/or dynamically allocating computational resources among the one or more solving units based on the optimization requirements. The one or more solving units may include at least one of a GLIDR OPT system, an LLM contextual infilling optimizer, or a COMPAS.

At 508, the system provides data from the structured data representation to the selected one or more solving units. In some implementations, the system transforms the structured data representation using one or more polynomial-time reduction algorithms before providing the transformed structured data representation to the one or more solving units. The system may select an output from the one or more solving units for generation of action data.

At 510, the system uses the selected one or more solving units to generate action data that causes an actuating device to perform one or more operations. In some implementations, generating the action data involves analyzing multiple operational domains (such as land, air, sea, space, or cyber domains) using domain-specific modules of the LLM and generating the action data to coordinate operations across the plurality of operational domains. The system may use the LLM to evaluate multiple candidate COAs based on various criteria and rank the candidate COAs. The one or more criteria may include, e.g., resource efficiency, probability of success, or associated risk.

At 512, the system provides the action data to the actuating device. After receiving the action data, the actuating device may perform the one or more operations. For example, the actuating device may generate and/or transmit one or more signals to one or more communicably connected devices. The signals may indicate operational commands, status updates, resource allocation instructions, or coordination directives for multi-domain operations. The actuating device may also perform physical operations such as activating mechanical components, adjusting system parameters, initiating automated processes, controlling robotic systems, or triggering emergency response protocols. In some implementations, the actuating device may execute a sequence of coordinated actions across multiple operational domains, such as simultaneously communicating with air, land, sea, space, or cyber assets to implement the recommended course of action.

A COA solver system, such as the system 100 of FIG. 1, can be used to integrate one or more components, such as a solver orchestration system adapted from GLIDR for dynamic solution space exploration, a COMPAS module configured to address optimization and satisfiability challenges, a custom LLM that contextualizes SAT variables and expands the solution space by incorporating missing relevant information, and a knowledge graph representation that enables the system to learn and reason over complex information structures. Together, these components may form a robust and adaptive system that can handle ambiguous/incomplete user specifications and generate innovative and/or alternative COAs for consideration.

In some implementations, the system uses an OODA loop to integrate with a RAG-enhanced LLM, enabling the system to process incoming intelligence data in real time. An OODA module can be configured to handle each phase of the OODA loop efficiently. First, the module can leverage a RAG framework to observe and retrieve relevant intelligence data from various sources, e.g., to ensure the most current and pertinent information is accessible to the system. Next, the data can be used to orient an LLM by integrating the data into the model's knowledge representation system, thereby allowing the LLM to adapt to changing scenarios with enhanced situational awareness. For the decision-making phase, the module can generate COAs through a process that combines the SAT solver with the GLIDR-MP orchestration mechanism, e.g., to ensure that generated strategies are both feasible and optimized for the mission's objectives. The OODA module can provide actionable COA outputs and continuously iterate through the OODA cycle based on feedback received from the operational environment.

In some implementations, the system can analyze and generate COAs that span multiple operational domains, including land, air, sea, space, and cyber. To do so, the system can include domain-specific modules, e.g., within the LLM, that are configured to capture unique characteristics and interactions of each domain. This can help ensure that generated COAs are comprehensive and effective across all areas of operation.

In some implementations, the system can implement a decomposition methodology, e.g., by decomposing COAs into discrete tasks. For example, in a humanitarian assistance scenario, tasks may include deploying medical units, setting up field hospitals, and distributing supplies. When coordinating such tasks, the system may account for logistical planning and coordination with local authorities. To manage such complexities, the system can use a structured formal language representation for objects, objectives, and affordances, linked via metadata relationships for LLM consumption. This formal language can be represented in knowledge graph form, e.g., leveraging graph databases, inductive learning systems, and LLMs for effective processing.

Modeling COAs as knowledge graphs can provide consistent semantic representation of relationships and help users identify critical paths and dependencies. Knowledge graphs can integrate diverse data sources, apply reasoning algorithms, and adapt to evolving information, which makes them suitable for dynamic military environments.

A COA knowledge graph can set initial conditions for Modeling and Simulation environments, such as AFSIM or OneSAF, which enables simulation-based assessments of COA feasibility. This functionality can enhance decision support. In some implementations, the system uses Generative AI, e.g., with CBAAM systems to enhance COA generation. This allows the system to form semantic connections and explore constrained COA correlations. These capabilities can be used to identify high-diversity connective reasoning pathways, e.g., for innovative COA development.

In some implementations, integration of GLIDR-MP and TEKGs can provide advanced knowledge representation and reasoning capabilities within the LLM framework, which allows the system to reason over complex military contexts and time-dependent relationships. GLIDR-MP can use a two-sweep advective message passing algorithm can help ensure efficient training convergence. GLIDR-OPT provides flexibility with various solver methods, e.g., by incorporating regressive learning algorithms and LLMs. This approach can help generate and refine COAs.

Implementing GLIDR and TEKG can enhance AI reasoning over complex information and time-dependent relationships. The system can access historical data, military doctrines, and operational scenarios. The system can use synthetic data generation, anonymization, and active learning techniques to adapt to new scenarios and develop a rich understanding of relationships between entities and events.

The GLIDR reasoning engine can use GLIDR-MP for efficient message passing and GLIDR-OPT for flexible optimization. GLIDR can support differentiable databases, e.g., allowing data-efficient learning and adaptability. The system can use a specialized predicate language and graph-database query structure to generate complex solutions, thereby extending GLIDR to include multiple solver engines such as COMPAS, GLIDR-OPT, and LLMs for knowledge graph representation and satisfiability concept generation.

By integrating RAG-enhanced intelligence with CBAAM, the system can identify high-diversity reasoning pathways and address complexity theory in modeling emergent behaviors across multi-domain operations (MDO), thereby enhancing strategic surprise by exploiting gaps in adversary expectations.

The system can be integrated with a custom satisfiability solver tool set, such as Combinatorial Optimization for Multi-domain Planning and Analysis System (COMPAS). The integration of select COMPAS tooling allows the system to efficiently represent and solve complex, constrained problems pertinent to military planning. By leveraging polynomial time reductions across NP-complete problem instances, the system can optimize COA generation and evaluation processes, e.g., to ensure that strategies are both innovative and feasible. COMPAS may include a custom satisfiability solver environment that is capable of addressing the combinatorial complexity of problems such as CoA development. These tools employ polynomial time reductions across NP-complete problem instances to efficiently represent satisfiability of constrained problems in different ways. For instance, COMPAS can transform SAT-type problems (e.g., 3-SAT, NAE-3-SAT, NAE-4-SAT) to MAXCUT and Assignment problems, where alternative heuristic solvers can be used for solution development. This allows the system to bypass difficulties in source domain (SAT) solutions. COMPAS can handle the complex, multi-domain nature of military planning and analysis, and assist with COA development and optimization.

In some implementations, the system uses a COMPAS SAT-solving framework, integrated with GLIDR-MP, to address the complex, constrained problems inherent in COAA. COMPAS can handle combinatorial optimization across NP-complete problem instances. COMPAS can be used to generate COAs that are both innovative and feasible. This integration can ensure that the LLM output aligns with tactical and strategic considerations, which enables planners to develop COAs that account for multi-domain operational constraints.

LLM contextual infilling capability can work in conjunction with COMPAS to iteratively adjust constraints and assumptions and/or to refine COAs to align with mission requirements. This iterative adjustment process, combined with GLIDR-OPT techniques, can help ensure generation of COAs that are well-suited for dynamic operational environments.

The system can utilize one or more advanced natural language processing (NLP) techniques within an LLM, e.g., to automate sorting or analysis of open-source (OS) data and publicly available information (PAI). These techniques can enrich actionable intelligence for COA generation, e.g., allowing the LLM to analyze diverse data sources efficiently. The system can include an automated workflow that integrates the RAG framework with the LLM, which can help ensure real-time COA development and enabling efficient processing of multi-domain intelligence.

The disclosed system can integrate diverse intelligence data, e.g., using a microservice architecture to manage processing load. This can help ensure scalability and flexibility, e.g., allowing LLMs to adapt to varying data constraints and support real-time COA development.

To support deployment in edge environments, the system can use a modular LLM architecture, e.g., optimized through model compression techniques such as quantization and pruning. This approach can reduce the computational footprint of an LLM and enable it to operate efficiently on edge devices. Federated learning can be employed to ensure that an LLM can learn from decentralized data sources, thus maintaining performance without centralized data access. Offline capabilities can enable the LLM to function effectively in environments with limited or fluctuating connectivity. By integrating model compression, federated learning, and offline functionality, LLMs can be adapted to various operational constraints, thereby ensuring reliable performance in diverse deployment scenarios.

The COAA-optimized LLM system described herein can provide robust COA development and evaluation. Each reference to a system, or the system, referred to herein can refer to the system of FIG. 1, the system of FIG. 4, or either system. The system can begin by receiving enriched intelligence data from the RAG module, which is then translated into a structured, formal representation by the LLM. This representation can be used to identify critical constraints, mission objectives, and potential adversary actions. The GLIDR-MP algorithm can select the appropriate solver component to process the data, including GLIDR-OPT for optimization, LLM contextual infilling for incomplete or ambiguous data, or COMPAS for complex combinatorial challenges. The SAT solver can operate on the constraints, objectives, and situational data to identify feasible COAs. The LLM can evaluate and rank one or more COAs based on key criteria such as resource efficiency, probability of mission success, and associated risks. The proposed COAs can then be presented to human analysts for feedback or directed implemented. Feedback can be used to refine the constraints, assumptions, or parameters. The system can offer explainability features, including confidence scores, detailed reasoning, and potential adversary counteractions, providing transparency into the decision-making process and enabling decision-makers to understand the rationale behind each COA recommendation. Explainability and transparency can make the system an ideal solution for high-stakes military operations or other applications.

By combining advanced LLM capabilities with robust solver components and explainability features, the COAA-optimized LLM system disclosed herein offers robust COA development and evaluation. The system's ability to handle changing operational scenarios and provide transparent recommendations makes it an effective tool for high-stake or dynamic environments, such as military operations.

The system's COA generation and analysis capabilities can be evaluated through simulation testing in multi-domain scenarios, followed by controlled real-world operational testing to assess performance in military environments. To ensure continuous improvement, a feedback loop with military personnel can be established to provide ongoing refinement based on their insights and experiences. Additionally, metrics can be used to measure the system's ability to generate disruptive COAs that create strategic surprise. This helps to ensure alignment with the demands of dynamic military operations.

Field trials can be used for testing purposes. The system can be deployed in controlled, real-world environment exercises, such as military exercises, working alongside planning teams. These trials can provide critical data on the system's integration with existing military planning processes, the impact on decision-making speed and quality, and usability in operational environments. Initial results indicate the system can significantly enhance the speed and depth of planning, while seamlessly integrating with established protocols.

Rigorous security testing can ensure resilience against cyber threats and data manipulation, while bias testing can be conducted to identify and mitigate any unintended biases in system outputs.

The system can use human decision support, e.g., to mitigate a risk of over-reliance on AI-generated recommendations, which could undermine human critical thinking in strategic planning. The system can be designed as a decision support tool rather than a replacement for human decision-making. Military planners can be trained to treat the system's outputs as valuable inputs to complement their expertise and judgment, not as definitive directives.

Another major risk involves adversarial manipulation of the system's inputs or algorithms, which can lead to flawed or compromised COAs. To address this issue, the system can include robust cybersecurity measures, including advanced encryption, continuous anomaly monitoring, and regular security audits. The system can include multiple independent data sources and cross-verification mechanisms to detect inconsistencies or manipulations in input data.

In some cases, the “black box” nature of AI decision-making can prompt concerns about transparency and accountability. To address these concerns, the system can use an explainable AI component to provide clear rationales for all COA recommendations. This enables planners to trace the logic behind each COA

Bias in system outputs can also result from bias in training data or algorithms. To mitigate this issue, rigorous testing protocols can be used to moderate system outputs, e.g., including diverse scenario testing and regular bias audits, to identify and eliminate biases. The system may be continuously updated, e.g., with feedback from military experts to ensure balanced performance across various operational contexts.

Reliance on complex technology can introduce risk of system failures during critical planning periods. To mitigate this issue, the system can include one or more robust backup and redundancy systems, e.g., to ensure continuity of planning capabilities, even during technical disruptions. Regular drills and training exercises can help personnel transition smoothly to alternative planning methods when necessary.

The disclosed system can provide a range of innovative, multi-domain COAs, e.g., that human analysts might overlook. Each result can be accompanied by additional data, such as detailed risk assessments, resource requirements, or projected outcomes. This helps enable decision-makers to make more informed choices. The system can continuously update one or more analyses, e.g., based on new data or user feedback. This can improve the likelihood of the system providing COA recommendations that are robust and adaptable in the face of changing circumstances, e.g., significantly enhancing agility and responsiveness in complex operational environments.

The disclosed system can seamlessly integrate considerations across land, air, maritime, space, and cyber domains, e.g., resulting in more comprehensive and effective strategies. As a result, planners may report increased confidence in addressing complex, interconnected challenges because the system can account for a wide range of factors and potential outcomes. The natural language interface of the system, depicted in FIG. 3, can democratize access to advanced planning tools, thus enabling a broader range of personnel to contribute meaningfully to the process. This can enrich strategic decision-making and foster better collaboration and knowledge sharing across branches and specialties within the military.

The disclosed system may include a RAG enhanced LLM specifically configured for OODA. The system can leverage dense passage retrieval techniques for efficient information extraction from military corpora, and integrate a transformer-based architecture for contextual understanding and generation of COAs.

The disclosed system can include a fine-tuned LLM using domain-specific datasets encompassing land, air, sea, space, and cyber domains. Transfer learning techniques and domain-adaptive pre-training can be used, e.g., to ensure a model captures unique characteristics and terminologies of each military domain.

The disclosed system can use a modular OODA loop system that interfaces with the RAG-enhanced LLM. The system can use an event-driven architecture to handle real-time data streams, and design state machines for each OODA phase to manage transitions and data flow between observe, orient, decide, and act stages.

The disclosed system can use a comprehensive knowledge graph schema that captures entities, relationships, and attributes relevant to military operations. The system can use ontology mapping techniques to align with existing military taxonomies and integrate automated knowledge extraction from unstructured military documents.

The disclosed system can use a GLIDR-MP system, e.g., using a two-sweep advective message passing algorithm. The system can include one or more custom neural network layers, e.g., for graph processing, and can implement backpropagation through time (BPTT) for efficient training on temporal graph structures.

The disclosed system can integrate TEKG capabilities into a knowledge representation system. The system can implement temporal logic frameworks, e.g., for reasoning over time-dependent events, and can develop indexing structures for efficient temporal query processing.

The disclosed system can include a differentiable database system, e.g., that supports inductive learning from labeled examples. The system can implement gradient-based optimization techniques for database operations and design differentiable query languages for seamless integration with neural network architectures.

The disclosed system can integrate a COMPAS solver into the COA generation pipeline. The system can implement polynomial-time reduction algorithms, e.g., for transforming military planning problems into SAT instances, and develop heuristics for efficient solution space exploration.

The disclosed system can include a GLIDR-OPT optimizer for COA refinement. The system can implement hybrid optimization techniques, e.g., that combine gradient-based approaches with combinatorial optimization methods. The system also can use adaptive learning rate schedules, e.g., for improved convergence in dynamic military scenarios.

The disclosed system may support LLM-driven iterative constraint adjustment for COA generation. The system can implement natural language understanding modules, e.g., to extract operational constraints from mission briefs, and can develop a feedback loop mechanism for continuous refinement of constraints based on LLM outputs.

The disclosed system can provide explainable AI features, e.g., for COA recommendations. The disclosed system can implement attention visualization techniques for transformer-based models, configure counterfactual explanation generators, and create interpretable decision trees for mapping the COA decision process.

The disclosed system supports advanced NLP techniques, e.g., for processing multi-source military data. The system can implement named entity recognition models configured for military entities, use multi-task learning architectures for simultaneous handling of various NLP tasks, and use domain-specific language models, e.g., for improved understanding of military jargon.

The disclosed system can use a cross-domain data fusion engine for integration of information from various military domains. The system can implement tensor-based fusion techniques for heterogeneous data types, use uncertainty quantification methods for data reliability assessment, and use a scalable distributed computing framework for real-time data integration.

The disclosed system can use an automated workflow system for COA development using LLMs and RAG. The system can use a microservices architecture for modular and scalable workflow management, event-driven processing pipelines for real-time COA updates, and adaptive load balancing algorithms for efficient resource utilization.

The disclosed system can use LLM-powered intelligent process automation, e.g., for military planning tasks. The system can use few-shot learning techniques, e.g., for rapid adaptation to new process types, reinforcement learning agents for optimizing process execution, and natural language interfaces for intuitive human-in-the-loop interactions.

The disclosed system can implement advanced model compression techniques for LLM deployment on edge devices. The system can also use quantization-aware training methods, pruning algorithms that maintain task-specific performance, or knowledge distillation techniques for creating compact student models.

The disclosed system can use a federated learning system for updating LLMs in decentralized environments. The system can implement secure aggregation protocols for privacy-preserving model updates, communication-efficient federated optimization algorithms, and adaptive participant selection methods for heterogeneous edge devices.

The disclosed system can implement offline inference and learning capabilities for LLMs in environments with limited or no connectivity. The system can implement model caching strategies for efficient offline use, incremental learning techniques for model updates with limited data, and checkpoint synchronization protocols for eventual consistency in disconnected operations.

The disclosed system can implement energy-aware computing algorithms for LLM operations in resource-constrained settings. The system can use dynamic voltage and frequency scaling techniques for adaptive power management, workload-aware scheduling algorithms for optimal resource utilization, and approximate computing methods for energy-efficient inference.

The disclosed system can be used in various areas, including disaster management and emergency response planning, where the system can be adapted to generate and evaluate response strategies for natural disasters or large-scale emergencies. The system can enhance decision-making capabilities for unmanned aerial systems (UAS) and other autonomous platforms in complex, dynamic environments. Additionally, the system can optimize resource allocation and response strategies for urban management and critical infrastructure protection in smart cities and infrastructure management applications.

The disclosed system can be used to develop strategies for addressing complex, multi-faceted challenges posed by climate change across various sectors. Furthermore, the system can enhance logistics and supply chain management in complex, global networks by generating adaptive strategies to disruptions or changing conditions for supply chain optimization.

The disclosed system can provide value in emergency management and public safety applications. The ability of the system to process complex, multi-source data and generate actionable strategies makes it invaluable for emergency response planning. City managers and emergency coordinators can leverage the described system to develop comprehensive response plans for natural disasters, public health crises, and large-scale emergencies. The edge computing capabilities of the system can ensure continuous operation even in connectivity-challenged environments, such as disaster response scenarios.

Healthcare systems can utilize the described techniques to optimize patient care pathways and resource allocation across multiple facilities. The system can analyze patient data, facility capabilities, and resource constraints to generate efficient treatment plans and staffing strategies. For remote or rural healthcare facilities, the edge-optimized architecture described herein can help ensure reliable decision support even with limited connectivity, enhancing care delivery in underserved areas.

Municipal authorities can employ the described system for urban planning and smart cities applications, e.g., to develop and evaluate complex infrastructure and transportation plans. By integrating data from various urban systems, including traffic patterns, utility usage, and population demographics, the system can generate optimized strategies for urban development, resource allocation, and public service delivery. The ability of the system to handle multi-domain interactions is particularly valuable for coordinating smart city initiatives across transportation, utilities, and public services.

Commercial enterprises can leverage the system to optimize complex supply chain networks and respond to disruptions in supply chain and logistics applications. The technology can analyze global supplier networks, transportation routes, and inventory levels to generate adaptive strategies for supply chain resilience. The ability of the system to operate in edge environments supports decision-making at remote warehouses and distribution centers, while the multi-domain integration capabilities enable comprehensive supply chain visibility and coordination.

Environmental protection agencies and organizations can utilize the system for climate change mitigation planning and environmental resource management. The system can process data from various environmental monitoring systems to develop strategies for pollution control, resource conservation, and sustainable development. The described techniques can handle complex, interconnected systems, making them particularly suitable for addressing multi-faceted environmental challenges.

Large enterprises can employ the described system for strategic planning and operational optimization across global operations in corporate strategy and operations contexts. The system can analyze market conditions, competitive landscapes, and internal capabilities to generate strategic options for market entry, expansion, or organizational transformation. The ability of the system to operate across distributed environments supports decision-making across multiple business units and geographical locations.

Scientific organizations can leverage the described system to support complex research planning and execution in research and development applications. The edge computing capabilities of the system enable data analysis and decision support in remote field locations, while multi-domain integration facilitates coordination across different research disciplines and methodologies.

Each of these applications demonstrates the versatility of the system in handling complex decision-making scenarios across various civilian and commercial contexts. The capabilities of the system, including multi-domain data integration, edge operation, and sophisticated strategy generation, provide value across sectors where complex planning and coordinated execution are important for success.

The scalable architecture and adaptable framework described herein enable customization for specific industry standards while maintaining the robust analytical capabilities, e.g., that help form the technology's foundation.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The subject matter and the actions and operations described in this specification can be implemented in digital electronic circuitry, in tangibly-embodied computer software or firmware, in computer hardware, including the structures disclosed in this specification and their structural equivalents, or in combinations of one or more of them. The subject matter and the actions and operations described in this specification can be implemented as or in one or more computer programs, e.g., one or more modules of computer program instructions, encoded on a computer program carrier, for execution by, or to control the operation of, data processing apparatus. The carrier can be a tangible non-transitory computer storage medium. Alternatively or in addition, the carrier can be an artificially-generated propagated signal, e.g., a machine-generated electrical, optical, or electromagnetic signal, that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., a field programmable gate array (FPGA), an application-specific integrated circuit (ASIC), or a graphics processing unit (GPU). The apparatus can also include, in addition to hardware, code that creates an execution environment for computer programs, e.g., code that constitutes processor firmware, a protocol stack, a database management system, an operating system, or a combination of one or more of them.

A computer program can be written in any form of programming language, including compiled or interpreted languages, or declarative or procedural languages; and it can be deployed in any form, including as a stand-alone program, e.g., as an app, or as a module, component, engine, subroutine, or other unit suitable for executing in a computing environment, which environment may include one or more computers interconnected by a data communication network in one or more locations.

A computer program may, in some implementations, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or both, or any other kind of central processing unit (CPU). Generally, a CPU will receive instructions and data from a read-only memory or a random access memory or both. The elements of a computer are a CPU for executing instructions and one or more memory devices for storing instructions and data. The CPU and the memory can be supplemented by, or incorporated in, special-purpose logic circuitry.

Generally, a computer will also include, or be operatively coupled to, one or more mass storage devices, and be configured to receive data from or transfer data to the mass storage devices. The mass storage devices can be, for example, magnetic, magneto-optical, or optical disks, or solid state drives. However, a computer does not have to include such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, the subject matter described in this specification can be implemented on one or more computers having, or configured to communicate with, a display device, e.g., a LCD (liquid crystal display) monitor, or a virtual-reality (VR) or augmented-reality (AR) display, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback and responses provided to the user can be any form of sensory feedback, e.g., visual, auditory, speech, or tactile feedback or responses; and input from the user can be received in any form, including acoustic, speech, tactile, or eye tracking input, including touch motion or gestures, or kinetic motion or gestures or orientation motion or gestures. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform the operations or actions. That one or more computer programs is configured to perform particular operations or actions means that the one or more programs include instructions that, when executed by data processing apparatus, cause the apparatus to perform the operations or actions. That special-purpose logic circuitry is configured to perform particular operations or actions means that the circuitry has electronic logic that performs the operations or actions.

The subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of what is being claimed, which is defined by the claims themselves, but rather as descriptions of features that may be specific to particular embodiments. Some features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in some combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this by itself should not be understood as requiring that such operations be performed in the particular order shown or in sequential order, or that all illustrated operations be performed, to achieve desirable results. In some circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
generating a structured data representation using a retrieval augmented generation system communicably connected to one or more data sources and a large language model;
providing the structured data representation to a graph-based logical induction with differentiable reasoning system;
selecting, using the graph-based logical induction with differentiable reasoning system, one or more solving units;
providing data from the structured data representation to the selected one or more solving units;
generating, by the selected one or more solving units, action data configured to cause an actuating device to perform one or more operations; and
providing the action data to the actuating device.

2. The method of claim 1, wherein the one or more solving units comprise at least one of (i) a graph-based logical induction with differentiable reasoning optimization system, (ii) large language model contextual infilling, or (iii) a combinatorial optimization for a multi-domain planning and analysis system.

3. The method of claim 1, wherein the structured data representation comprises at least one of a knowledge graph or a graph schema.

4. The method of claim 1, wherein the one or more data sources include one or more databases accessible via separate wireless networks.

5. The method of claim 1, comprising:
performing, using the actuating device, the one or more operations after receiving the action data.

6. The method of claim 5, wherein performing the one or more operations comprises generating and transmitting one or more signals to one or more communicably connected devices.

7. The method of claim 1, wherein generating the structured data representation comprises:
extracting information from the one or more data sources using dense passage retrieval; and
converting the extracted information into a knowledge graph representation using the large language model.

8. The method of claim 1, wherein the graph-based logical induction with differentiable reasoning system selects the one or more solving units based on characteristics of the structured data representation, the characteristics comprising at least one of mission constraints, mission objectives, or potential adversary actions.

9. The method of claim 1, comprising:
evaluating, using the large language model, a plurality of candidate courses of action based on one or more criteria; and
ranking the plurality of candidate courses of action, wherein the action data corresponds to a highest-ranked course of action.

10. The method of claim 9, wherein the one or more criteria comprise at least one of resource efficiency, probability of success, or associated risk.

11. The method of claim 1, comprising:
receiving feedback data from one or more user devices; and
refining one or more parameters of the graph-based logical induction with differentiable reasoning system based on the feedback data, wherein the one or more parameters comprise at least one constraint, assumption, or operational parameter.

12. The method of claim 1, comprising:
processing the action data using an iterative framework, wherein processing the action data comprises:
retrieving intelligence data from the one or more data sources using the retrieval augmented generation system;
integrating the retrieved intelligence data into a knowledge representation system of the large language model;
generating the action data using the graph-based logical induction with differentiable reasoning system and the selected one or more solving units;
providing the action data to the actuating device; and
receiving operational feedback for subsequent iterations.

13. The method of claim 1, wherein the structured data representation comprises a temporal event knowledge graph configured to represent time-dependent relationships between entities and events, and wherein the graph-based logical induction with differentiable reasoning system performs reasoning over the time-dependent relationships.

14. The method of claim 1, comprising:
generating explainability data associated with the action data, wherein the explainability data comprises at least one of a confidence score, a reasoning pathway, or a potential counteraction; and
providing the explainability data to one or more user devices.

15. The method of claim 1, wherein generating the action data comprises:
analyzing a plurality of operational domains comprising land, air, sea, space, or cyber domains using domain-specific modules of the large language model; and
generating the action data to coordinate operations across the plurality of operational domains.

16. The method of claim 1, wherein the method is performed within a resource-constrained environment, and wherein at least one of the retrieval augmented generation system, the large language model, or the graph-based logical induction with differentiable reasoning system is configured for edge computing through at least one of model compression, quantization, pruning, or federated learning.

17. The method of claim 1, wherein the graph-based logical induction with differentiable reasoning system implements a two-sweep advective message passing algorithm for processing the structured data representation, and wherein selecting the one or more solving units comprises:
determining a complexity level of constraints within the structured data representation;
identifying optimization requirements based on the complexity level; and
dynamically allocating computational resources among the one or more solving units based on the optimization requirements.

18. The method of claim 1, comprising:
transforming the structured data representation using one or more polynomial-time reduction algorithms;
applying the one or more solving units to the transformed structured data representation; and
selecting an output from the one or more solving units, wherein the action data is generated based on the selected output.

19. A system comprising:
one or more processors; and
memory storing instructions that, when executed by the one or more processors, cause the system to perform operations comprising:
generating a structured data representation using a retrieval augmented generation engine communicably connected to one or more data sources and a large language model;
providing the structured data representation to a graph-based logical induction with differentiable reasoning service;
selecting, using the graph-based logical induction with differentiable reasoning service, one or more solving units;
providing data from the structured data representation to the selected one or more solving units;
generating, by the selected one or more solving units, action data configured to cause an actuating device to perform one or more operations; and
providing the action data to the actuating device.

20. A non-transitory computer-readable medium storing instructions that, when executed by one or more processors, cause the one or more processors to perform operations comprising:
generating a structured data representation using a retrieval augmented generation system communicably connected to one or more data sources and a large language model;
providing the structured data representation to a graph-based logical induction with differentiable reasoning system;
selecting, using the graph-based logical induction with differentiable reasoning system, one or more solving units;
providing data from the structured data representation to the selected one or more solving units;
generating, by the selected one or more solving units, action data configured to cause an actuating device to perform one or more operations; and
providing the action data to the actuating device.
